(19) United States
(12) Patent Application Publication
(10) Pub. No.: US 2025/0278803 A1
(43) Pub. Date: Sep. 4, 2025

(54) INFORMATION PROCESSING METHOD, INFORMATION PROCESSING DEVICE, INFORMATION PROCESSING SYSTEM, AND RECORDING MEDIUM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/191,493

(22) Filed: Apr. 28, 2025

Related U.S. Application Data
(63) Continuation of application No. PCT/JP2023/035717, filed on Sep. 29, 2023.

(30) Foreign Application Priority Data
Nov. 15, 2022 (JP) 2022-182337

(51) Int. Cl. G06Q 50/16

(52) U.S. Cl. CPC G06Q 50/16

(57) ABSTRACT

An information processing method includes: obtaining attribute information and possession information, the attribute information including ages of one or more users at a reference point in time, the possession information indicating possessions owned by the one or more users at the reference point in time; obtaining amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and obtaining future information indicating possessions to be owned by the one or more users in future by correcting the standard information using the amount information obtained, and providing the future information.

### CROSS REFERENCE TO RELATED APPLICATIONS

This is a continuation application of PCT International Application No. PCT/JP2023/035717 filed on Sep. 29, 2023, designating the United States of America, which is based on and claims priority of Japanese Patent Application No. 2022-182337 filed on Nov. 15, 2022. The entire disclosures of the above-identified applications, including the specifications, drawings and claims are incorporated herein by reference in their entirety.

### FIELD

The present disclosure relates to an information processing method, an information processing device, an information processing system, and a recording medium.

### BACKGROUND

There is a disclosure of a technique suggesting a new floor plan of a residence reflecting the current lifestyle of a resident (see Patent Literature (PTL) 1).

### CITATION LIST

### Patent Literature

PTL 1: Japanese Patent No. 6906384

### SUMMARY

It is however not easy for a person viewing a residence to image the space required in the residence in the future if the person lives in the residence. Similarly, it is not easy for a person viewing a facility to image the space required in the facility in the future if the person lives in the facility.

To address the problems, the present disclosure provides an information processing method, and so on, which provide a user with information indicating the space required in a facility in the future.

An information processing method according to an aspect of the present disclosure is to be executed by an information processing device using a processor. The information processing method includes: obtaining attribute information and possession information, the attribute information including ages of one or more users at a reference point in time, the possession information indicating possessions owned by the one or more users at the reference point in time; the obtaining amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and obtaining future information indicating possessions to be owned by the one or more users in future by correcting the standard information using the amount information obtained, and providing the future information.

Note that the general and specific aspect of the present disclosure may be implemented using a system, a device, an integrated circuit, a computer program, or a computer-readable recording medium, such as a CD-ROM, or any combination of systems, devices, integrated circuits, computer programs, or recording media.

The information processing method according to the present disclosure can provide a user with information indicating the space required in a facility in the future.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an illustration schematically showing a configuration of an information processing system according to an embodiment.

FIG. 2A is an illustration showing a first example of standard information according to the embodiment.

FIG. 2B is an illustration showing a second example of the standard information according to the embodiment.

FIG. 2C is an illustration showing a third example of the standard information according to the embodiment.

FIG. 3 is an illustration showing an example of attribute information and possession information according to the embodiment.

FIG. 4 is an illustration showing a first example of string information indicating the spaces occupied by possessions according to the embodiment.

FIG. 5 is an illustration showing a second example of the string information indicating the spaces occupied by the possessions according to the embodiment.

FIG. 6 is an illustration showing a third example of the string information indicating the spaces occupied by the possessions according to the embodiment.

FIG. 7 is an illustration showing a first example of a floor plan image according to the embodiment.

FIG. 8 is an illustration showing a second example of the floor plan image according to the embodiment.

FIG. 9 is an illustration showing a third example of the floor plan image according to the embodiment.

FIG. 10 is an illustration showing a fourth example of the floor plan image according to the embodiment.

FIG. 11 is an illustration showing a fifth example of the floor plan image according to the embodiment.

FIG. 12 is an illustration showing a sixth example of the floor plan image according to the embodiment.

FIG. 13A is an illustration showing a first example of a 3D-image according to the embodiment.

FIG. 13B is an illustration showing a second example of the 3D-image according to the embodiment.

FIG. 14A is an illustration showing a third example of the 3D-image according to the embodiment.

FIG. 14B is an illustration showing a fourth example of the 3D-image according to the embodiment.

FIG. 15 is an illustration showing a fifth example of the 3D-image according to the embodiment.

FIG. 16 is a flowchart showing processing to be executed by a server according to the embodiment.

### DESCRIPTION OF EMBODIMENT

### Underlying Knowledge Forming Basis of the Present Disclosure

The present inventor found that the technique related to the residence space described in the “Background” arises the following problems.

In general, the life stages of people change in accordance with the aging of the people, and the possessions owned by the people also change in accordance with the life stages. The possessions here mean movables placed in a residence and used in daily life and may include furniture, home appliances, books, or clothes, for example.

For example, it is found that people in their teens and twenties own a relatively small amount of possessions and the possessions used by themselves tend to account for a relatively high percentage of the total amount. On the other hand, it is found that people in their thirties to fifties own a relatively large amount of possessions and the possessions used by themselves tend to account for a relatively low percentage of the total amount. In other words, it is found that the possessions owned by thirties to fifties tend to include those shared with the other family member(s) or those used by the other family member(s) in addition to those used by themselves.

In accordance with the aging of people, the people may tend to own relatively expensive possessions, relatively durable possessions, or relatively large possessions.

The amount of the space in a residence may be one of the criteria for selecting the residence in which a person lives. This is because there is a need to place the possessions owned by himself/herself and the other family member(s) in the space in the residence and keep a space without the possessions, if the person lives in the residence.

It may be however difficult for a person who views the real residence or the information (e.g., the floor plan) indicating the residence to image the amount of possessions in the future. The person cannot thus easily image the space required in the residence in the future if living in the residence. Similarly, a person who views a facility cannot thus easily image the space required in the facility in the future if living in the facility.

To address the problems, the present disclosure provides an information processing method, and so on, which provide a user with information indicating the space required in a facility in the future.

Examples of the features obtained from the disclosure of this specification are raised and the advantages obtained from the invention will be described.
(1) An information processing method is to be executed by an information processing device using a processor. The information processing method includes: obtaining attribute information and possession information, the attribute information including ages of one or more users at a reference point in time, the possession information indicating possessions owned by the one or more users at the reference point in time; the obtaining amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and obtaining future information indicating possessions to be owned by the one or more users in future by correcting the standard information using the amount information obtained, and providing the future information.

According to the aspect described above, the information processing method provides the future information obtained in accordance with the possessions owned by the users. The future information to be provided reflects the amount of possessions to be owned by the users in the future, based on the amount of the possessions owned by the users. Accordingly, the users who view the future information can specifically recognize the spaced to be occupied by the possessions that may be placed in the facility in the future and grasp the space required in the facility in the future. In this manner, the information processing method can present, to the users, the information indicating the space required in the facility in the future.
(2) In the information processing method described in (1), the obtaining of the future information includes: obtaining, as the future information, an image obtained by combining an image showing the possessions to be owned by the one or more users in the future with an image showing a facility in which at least one of the users considers living.

According to the aspect described above, the information processing method provides, as the future information, the image combined with the image showing the possessions to be owned by the users in the future. Accordingly, the users can recognize the spaces to be occupied by the possessions to be owned by the users in the future more specifically. The information processing method can thus present, to the users, the information indicating the space required in the facility in the future more specifically.
(3) In the information processing method described in (1) or (2), the obtaining of the future information includes: obtaining, as the future information, an image obtained by combining a three-dimensional (3D) image showing the possessions to be owned by the one or more users in the future with a 3D image showing a facility in which at least one of the users considers living.

According to the aspect described above, the information processing method provides, as the future information, the 3D-image combined with the image showing the possessions to be owned by the users in the future. Accordingly, the users can recognize the spaces to be occupied by the possessions to be owned by the users in the future more specifically and intuitively. The information processing method can thus present, to the users, the information indicating the space required in the facility in the future more specifically and intuitively.
(4) The information processing method described in (1) or (2) further includes: obtaining location and orientation information indicating a location and an orientation of a terminal. The obtaining of the future information includes: obtaining, as the future information, a three-dimensional (3D) image obtained by combining a 3D-image showing possessions to be owned by the one or more users in the future with a 3D-image showing the facility in which the user considers living, and providing the 3D-image to the terminal.

According to the aspect described above, the information processing method provides, as the future information, the 3D-image combined with the image showing the possessions to be owned by the users in the future when the facility is seen from the terminal. The users can recognize the spaces to be occupied by the possessions to be owned by the users in the future more specifically and intuitively by virtually viewing the space in the facility. The information processing method can thus present, to the users, the information indicating the space required in the facility in the future more specifically and intuitively.
(5) In the information processing method described in (1) or (2), the obtaining of the future information includes: obtaining, as the future information, an image obtained by combining an image showing possessions to be owned by the one or more users in the future with an image showing a floor plan of the facility in which the user considers living.

According to the aspect described above, the information processing method provides, as the future information, the floor plan image combined with the image showing the possessions to be owned by the user in the future. Accordingly, the users can recognize the spaces to be occupied by the possessions to be owned by the users in the future more specifically and intuitively. The information processing method can thus present, to the users, the information indicating the space required in the facility in the future more specifically and intuitively.
(6) In the information processing method described in any one of (1) to (5), the obtaining of the future information includes: obtaining the future information including an image of an avatar of at least one of the one or more users who consider living to the facility.

The aspect described above provides, as the future information, the image by combining the image showing the possessions to be owned by the users in the future and an avatar of at least one of the users. Accordingly, the users can recognize the possessions to be owned by the users in the future and the shapes of themselves in the facility more specifically. The users can understand the space in the facility more easily in comparison with the size of the avatar of the user. The information processing method can thus present, to the user, information indicating the space required in the facility in the future more specifically.
(7) In the information processing method described in (1), the obtaining of the future information includes: obtaining, as the future information, string information indicating spaces to be occupied by possessions to be owned by the one or more users in the future.

According to the aspect described above, the information processing method provides, as the future information, the string information indicating the spaces occupied by the possessions to be owned by the users in the future. Accordingly, the users can recognize the spaces to be occupied by the possessions to be owned by the users in the future more specifically. The information processing method can thus present, to the users, information indicating the space required in the facility in the future more specifically.
(8) In the information processing method described in any one of (1) to (7), the obtaining of the future information includes: obtaining future information indicating possessions to be owned by the one or more users after N years, where N is an integer of one or more, from the reference point in time.

According to the aspect described above, the information processing method includes obtaining the future information in association with number N of years elapsed. Accordingly, the users can recognize the spaces to be occupied by the possessions to be owned by the users in the future specifically in association with the number of years elapsed. The information processing method can thus present, to the users, the information indicating the space required in the facility in the future more specifically.
(9) In the information processing method described in any one of (1) to (8), the attribute information further includes sexes or occupations of the one or more users. The standard information indicates the standard spaces occupied by possessions owned by the people and determined in advance for the ages of the people and sexes or occupations of the people.

According to the aspect described above, in the information processing method, the attribute information further includes the sexes or occupations of the users. The information processing method includes obtaining the future information in accordance with the sexes or occupations of the users more accurately. Accordingly, the users can recognize the spaces to be occupied by the possessions to be owned by the users in the future more accurately. The information processing method can thus present, to the users, the information indicating the space required in the facility in the future more specifically and accurately.
(10) In the information processing method described in (1), the facility to which the user considers living is a residence. The one or more users are one or more residents who consider living to the residence.

According to the aspect described above, the information processing method provides the future information obtained in accordance with the possessions owned by the residents. The future information to be provided reflects the amount of the possessions to be owned by the residents in the future, based on the amount of the possessions owned by the resident. Accordingly, the users viewing the future information can recognize the spaces to be occupied by the possessions that may be placed in the facility in the future specifically and grasp the space required for the facility in the future. In this manner, the information processing method can present, to the users, the information indicating the space required in the facility in the future.
(11) An information processing device includes: an obtainer that obtains attribute information and possession information, the attribute information including ages of one or more users at a reference point in time, the possession information indicating possessions owned by the one or more users at the reference point in time; a calculator that obtains, using a processor, amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and a provider that obtains and provides future information indicating possessions to be owned by the one or more users in future by correcting the standard information using the amount information obtained. The aspect described above provides at least the same advantages as the information processing method described above.
(12) An information processing system includes: the information processing device described in (11); and a terminal including a display that displays the future information provided by the information processing device.

The aspect described above provides at least the same advantages as the information processing method described above.
(13) The aspect is directed to a non-transitory computer-readable recording medium for use in a computer. The recording medium has recorded thereon a computer program for causing the computer to execute the information processing method described in (1).

The aspect described above provides at least the same advantages as the information processing method described above.

Note that these general and specific aspects of the present disclosure may be implemented using a system, a device, an integrated circuit, a computer program, or a computer-readable recording medium, such as a CD-ROM, or any combination of systems, devices, integrated circuits, computer programs, or recording media.

Now, an embodiment will be described in detail with reference to the drawings.

Note that the embodiment described below is a mere general or specific example of the present disclosure. The numerical values, shapes, materials, elements, the arrangement and connection of the elements, steps, step orders etc. shown in the following embodiment are thus mere examples, and are not intended to limit the scope of the present disclosure. Among the elements in the following embodiment, those not recited in the independent claims defining the broadest concept will be described as optional.

### EMBODIMENT

In this embodiment, an information processing method, and so on, which provide a user with information indicating the space required in a facility in the future will be described.

The facility is a residence, for example, which will be described as an example. The facility may be an office, a hospital, or a shop, for example. If the facility is a house, the user who considers living in the facility corresponds to a possible resident of the house. If the facility is an office, the user who considers living in the facility corresponds to a possible worker in the office.

An example will be described where a user considers living in a possible residence to which this embodiment is applied. In other words, the possible residence is different from the current residence of the user and the user may live in the possible residence in the future. The user may intend to make a contract to purchase or rent the possible residence, for example.

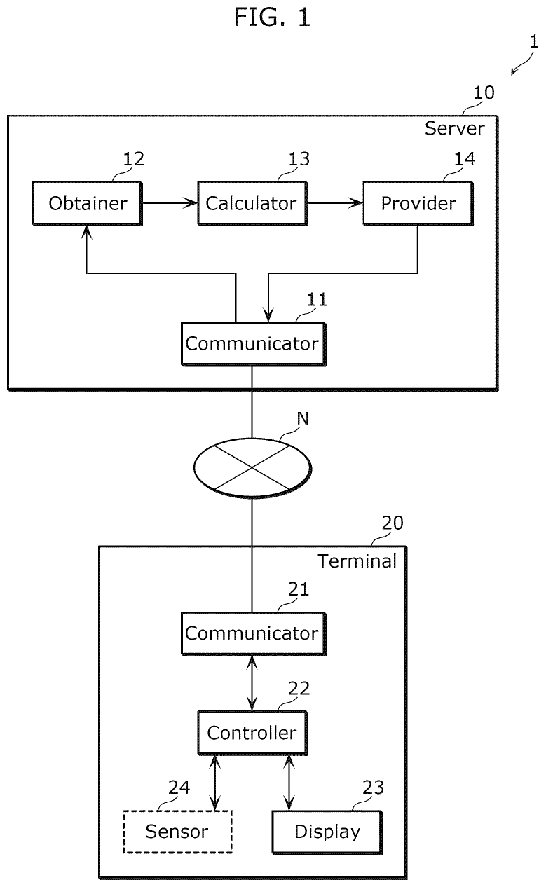

FIG. 1 is an illustration schematically showing a configuration of information processing system 1 according to this embodiment. As shown in FIG. 1, information processing system 1 includes server 10 and terminal 20. Server 10 and terminal 20 are connected to network N directly or indirectly and communicable with each other via network N.

Network N may be any communication line or network and may include the Internet, a mobile carrier network, an access network of an internet provider, or a public access network, for example.

Server 10 is a device that generates information indicating the space required in the residence in the future. Server 10 transmits the generated information through network N to terminal 20.

Server 10 includes communicator 11, obtainer 12, calculator 13, and provider 14. Obtainer 12, calculator 13, and provider 14 are achieved by at least a processor (not shown) included in server 10 and executing a predetermined program, using a memory (not shown).

Communicator 11 is a communication interface connected to network N. Communicator 11 is communicably connected to communicator 21 of terminal 20 via network N. Communicator 11 is a communication interface for wired communications, for example, but may be a communication interface for wireless communications.

Obtainer 12 obtains information necessary for the processing to be executed by server 10. Specifically, obtainer 12 obtains at least attribute information and possession information. The attribute information includes at least respective ages of one or more residents at a reference point in time. The attribute information may further include the sexes or occupations of the one or more residents at the reference point in time. The reference point in time may be any point in time and may be, for example, a point in time when obtainer 12 has obtained the attribute information or the possession information, or a point in time in the past or future.

The attribute information may further include the differences among infants, toddlers, or students (children or students) of the one or more residents at the reference point in time. More specifically, the attribute information may include the differences among kindergarten children, elementary school students, junior high school students, high school students, university students, graduate students (the first half of doctoral course), and graduate students (the second half of doctoral course). The attribute information may further include the role (i.e., father, husband, mother, wife, child, boy, or girl) of each resident in the family, the place (e.g., kitchen) in which the resident stays at a relatively high frequency in the residence, and the position (e.g., standing) often taken by the resident in the place, the personality, hobbies, favors, or other characteristics of the resident. Obtainer 12 may obtain the attribute information from terminal 20 via network N and communicator 11, or may read the attribute information stored in advance in a storage device (not shown).

The possession information indicates the possessions owned by the one or more residents at the reference point in time. Obtainer 12 may obtain the possession information from terminal 20 via network N and communicator 11, or may obtain the possession information by reading the attribute information stored in advance in a storage device (not shown).

Obtainer 12 can also obtain, from terminal 20, information (also referred to as “location and orientation information”) indicating the locations and orientations of the users. More specifically, the locations and orientations of the users are the locations and orientations of the heads of the users.

Calculator 13 obtains amount information indicating the amount of the possessions owned by the one or more residents, based on the information obtained by obtainer 12. Specifically, calculator 13 obtains the amount information indicating the amount of the possessions owned by the one or more residents by comparing standard spaces to the spaces occupied by the possessions indicated by the possession information. The standard spaces are for the one or more residents and obtained from the attribute information and the standard information obtained by obtainer 12.

The standard information is here the information indicating the standard spaces. The standard spaces are determined in advance for the respective ages of people and occupied by the possessions owned by the people. The standard information may indicate standard spaces determined in advance for the respective ages of the people and the respective sexes or occupations of the people and occupied by standard possessions owned by the people.

Note that the standard information may include information on the locations of the standard possessions owned by the people. For example, the standard information may include information specifying the rooms (e.g., a living room) in which the possessions are to be placed or information specifying possible locations (for example, on a wall) of the possessions in the rooms.

Specifically, the spaces occupied by possessions are represented by the volumes occupied by the possessions, or the areas occupied by the possessions. Note that the volumes occupied by the possessions are the capacities occupied by the possessions. The areas occupied by the possessions are, in other words, the areas of the regions occupied when the possessions are reflected on the floor.

The amount information may be obtained as the percentages the spaces occupied by the possessions owned by the one or more residents with respect to the standard spaces for the residents, for example (see the following Equation (1)).

Amount information=Space occupied by possessions owned by residents/Standard space for possessions of residents . . . (1)

For example, the amount information indicates 120%, where the standard space for the possessions of the residents is 10 m³, and the space occupied by the possessions owned by the resident is 12 m³.

Note that calculator 13 may obtain the amount information on the whole residence or may obtain the amount information for each room of the residence.

Calculator 13 may obtain the amount information from Equation (1) described above a plurality of times and regards the average of the amount information obtained the plurality of times as the amount information. For example, assume that the amount information obtained from Equation (1) two years ago is 118%, the amount information obtained from Equation (1) one year ago is 122%, the amount information obtained from Equation (1) at the current point in time is 120%. In this case, the average 120% among 118%, 122%, and 120% may be regarded as the amount information.

Note that the “Space occupied by possessions owned by residents” in Equation (1) may represent the area or volume of the possessions assumed by image recognition processing of a camera image captured by a user holding a smartphone in the residence.

Provider 14 obtains future information indicating the possessions to be owned by the one or more residents in the future and provides terminal 20 with the future information. Specifically, provider 14 obtains the future information described above by correcting the standard information using the amount information obtained by calculator 13. Provider 14 may obtain the future information on the whole residence or may obtain the future information on each room of the residence. The future information may include various types of information.

When obtaining the future information, provider 14 can obtain, as the future information, an image obtained by combining an image showing the possessions to be owned by the one or more residents in the future with an image showing the residence in which the resident considers living. The image described above may be a three-dimensional (3D) image or a two-dimensional (2D) image.

Specific examples of the 3D-image include an image showing objects inside the residence (more specifically, building and construction materials of the residence (hereinafter referred to as the “building and other materials”) or possessions to be placed in the residence) as seen from a specific point inside the residence. In other words, when obtaining the future information, provider 14 can obtain, as the future information, an image obtained by combining a 3D-image showing the possessions to be owned by the one or more residents in the future with a 3D-image showing the residence through image processing.

Assume that server 10 (i.e., obtainer 12) obtains information (referred to as “location and orientation information”) indicating the locations and orientations of the users from terminal 20. In this case, provider 14 can obtain, as the future information, a 3D-image obtained by combining a 3D-image showing the possessions to be owned by the one or more residents in the future with a 3D-image showing the residence seen from terminal 20 at the location and orientation indicated by the location and orientation information. When newly obtaining location and orientation information from terminal 20, provider 14 obtains, as the future information, a new 3D-image based on the newly obtained location and orientation information. Accordingly, terminal 20 can update the 3D-image in real time every time when the location and orientation of terminal 20 change.

If provider 14 obtains a 3D-image as the future information, this 3D-image differs in accordance with the fact whether the display screen of display 23 included in terminal 20 is transmissive or non-transmissive. If the display screen is transmissive, provider 14 obtains, as the future information, a 3D-image superimposed on the scene viewed by the user behind the display screen. If the display screen is non-transmissive, provider 14 obtains, as the future information, the whole 3D-image viewed by the user.

Specific examples of the 2D-image include an image showing objects inside the residence (more specifically, the building and other materials of the residence or the possessions to be placed in the residence) when the whole or a part of the residence is seen from above. A 2D-image corresponds to the image obtained by placing the possessions on an image showing what is called a floor plan of the residence. In other words, when obtaining the future information, provider 14 can obtain, as the future information, an image obtained by combining an image showing the possessions to be owned by the one or more residents in the future with an image showing the floor plan of the residence. Note that in which rooms the possessions described above are to be placed in the residence may be determined freely. If including the information specifying the rooms or locations in which the possessions are to be placed, the standard information may be referred to for the determination.

When obtaining the future information, provider 14 may obtain future information including an image including an avatar of at least one of the residents who will live in the residence.

Note that factors (e.g., specific shapes, patterns, or colors of the building and other materials or the possessions) irrelevant to the spaces in the residence in a 3D-image or a 2D-image may be omitted or simplified.

When obtaining the future information, provider 14 can obtain, as the future information, information indicating the spaces to be occupied by possessions to be owned by one or more residents in the future.

When obtaining the future information, provider 14 can obtain future information indicating the possessions to be owned by one or more residents after N years from the reference point in time in association with number N of years elapsed. Here, N is an integer of one or more. If the future information is in the form of an image, the image may include string information indicating number N of years elapsed.

Terminal 20 is a device that obtains information indicating the space required in the residence in the future from server 10 and presents the information to the user. Terminal 20 may be a portable information terminal (e.g., a smartphone, a tablet, or a personal computer), a wearable information terminal (virtual reality (VR) headsets, augmented reality (AR) glasses, or a head mounted display), or a stationary information terminal (e.g., a personal computer).

Terminal 20 includes communicator 21, controller 22, and display 23. If being an attachable information terminal, terminal 20 may further include sensor 24.

Communicator 21 is a communication interface connected to network N. Communicator 21 is communicably connected to communicator 11 of server 10 via network N. Communicator 21 is a communication interface for wireless communications, for example, which will be described as an example. Communicator 21 may be however a communication interface for wired communications.

Controller 22 controls the components of terminal 20. Specifically, controller 22 generates information to be transmitted by communicator 21 and causes communicator 21 to transmit the information, or obtains information received by communicator 21 and executes processing. Controller 22 also generates image data to be displayed on a display screen by display 23, provides the generated image data to display 23, and causes the display screen to display an image. If terminal 20 includes sensor 24, controller 22 obtains a sensing value generated by sensor 24 and transmits the sensing value through communicator 21 to server 10.

Assume that controller 22 owns the attribute information or the possession information on the users, or obtains the attribute information or the possession information on the users via user interfaces (not shown). In this case, controller 22 provides server 10 with the attribute information or the possession information via network N and communicator 21. If terminal 20 includes sensor 24, controller 22 provides the location and orientation information obtained by sensor 24 to server 10 via network N and communicator 21.

Display 23 includes the display screen and displays image data on the display screen. Display 23 obtains the image data generated by server 10 through network N and controller 22, and displays an image on the display screen based on the obtained image data. The displayed image is assumed to be viewed by the user. The image displayed by display 23 is a 2D-image or 3D-image showing future information. If terminal 20 includes sensor 24, the image displayed by display 23 may be 3D-image according to the location and orientation information on terminal 20.

Note that the display screen included in display 23 may be transmissive or non-transmissive. If the display screen is transmissive, the user see an image displayed on the display screen while viewing the scene behind the display screen through the display screen to recognize both the scene described above and the image described above. In other words, the user recognizes, together with the scene behind the display screen, a 3D-image superimposed on that scene. If the display screen is non-transmissive, the user recognizes an image displayed on the display screen.

Sensor 24 senses the location and orientation of terminal 20 and generates a sensing value indicating the information on the location and orientation of terminal 20. The location and orientation of terminal 20 reflects the location and orientation of the user (more specifically the head of the user) wearing terminal 20. Sensor 24 provides controller 22 with the generated sensing value.

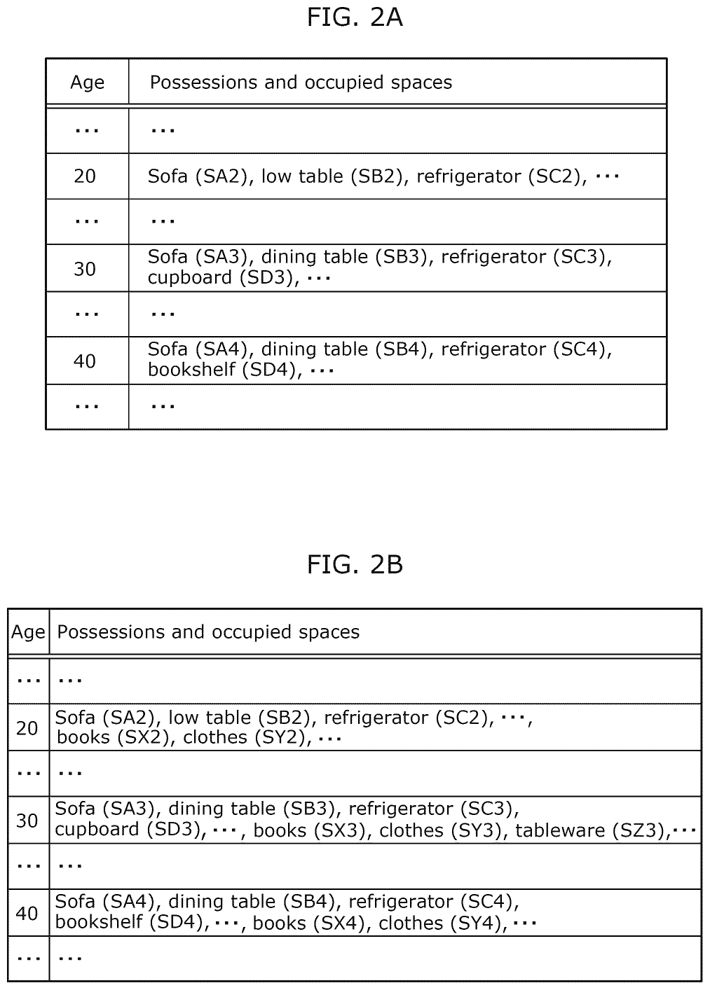

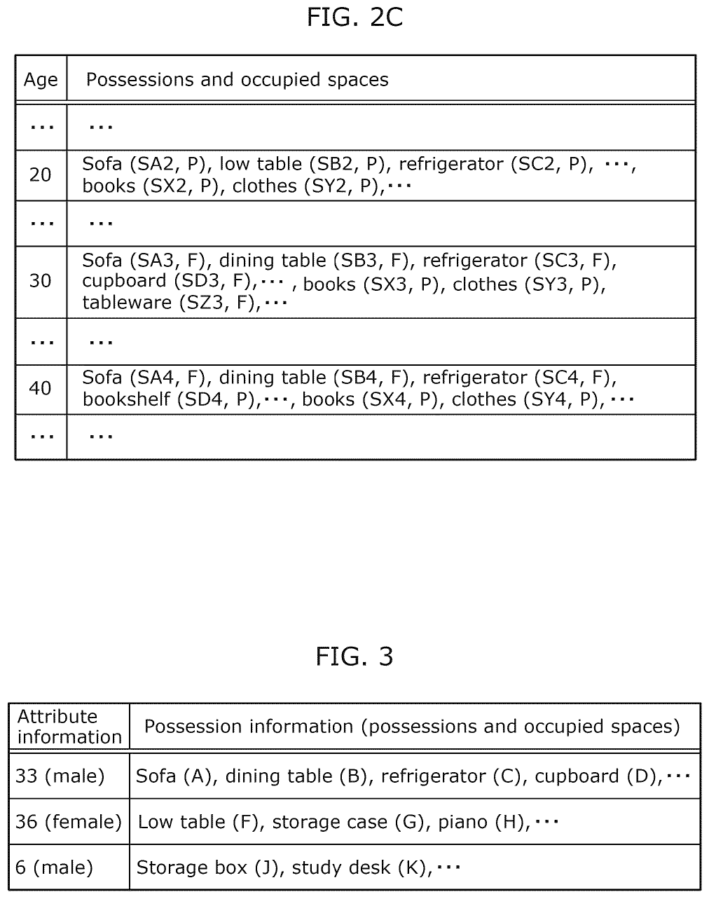

Examples of the standard information will be described with reference to FIGS. 2A to 2C.

FIG. 2A is an illustration showing a first example of the standard information according to this embodiment.

FIG. 2A shows, for the respective ages of people, the types of standard possessions owned by the people and the spaces occupied by these possessions in association with each other. FIG. 2A shows 20, 30, and 40 as specific examples of the ages of people. Note that the brackets following the names of the possessions indicate the spaces occupied by these possessions.

For example, a sofa, a low table, and a refrigerator are shown as the standard possessions owned by a 20 year-old person. The spaces occupied by these possessions are: SA2, SB2, and SC2, respectively. SA2 and the other spaces are represented by the numerical values indicating the volumes or the numerical values indicating the areas, for example. The same applies to the following.

For example, a sofa, a dining table, a refrigerator, and a cupboard are shown as the standard possessions owned by a 30 year-old person. The spaces occupied by these possessions are: SA3, SB3, SC3, and SD3, respectively.

For example, a sofa, a dining table, a refrigerator, and bookshelf are shown as the standard possessions owned by a 40 year-old person. The spaces occupied by these possessions are: SA4, SB4, SC4, and SD4, respectively.

While showing the respective standard information for the ages, FIG. 2A may show the standard information for groups of ages. The groups of ages may be separated in five or ten years, for example. The groups of ages are not necessarily separated at equal intervals. Note that the standard information may indicate the possessions and the occupied spaces in association with each other not for the ages of people but for the sexes or occupations of people.

FIG. 2B is an illustration showing a second example of the standard information according to this embodiment.

Like FIG. 2A, FIG. 2B shows, for respective ages of people, the types of standard possessions owned by the people and the spaces occupied by these possessions in association with each other. FIG. 2B shows possessions (e.g., books, clothes, or tableware) easily portable by the people, in addition to the possessions (e.g., the sofa, the table, or the refrigerator) assumed to be fixed onto the floor and used.

For example, books and clothes are shown as the standard possessions owned by a 20 year-old person, in addition to the sofa, the low table, and the refrigerator. The spaces occupied by the added possessions are: SX2 and SY2, respectively.

For example, books, clothes, and tableware are shown as the standard possessions owned by a 30 year-old person, in addition to the sofa, the dining table, the refrigerator, and the cupboard. The spaces occupied by the added possessions are: SX3, SY3, and SZ3, respectively.

For example, books and clothes are shown as the standard possessions owned by a 40 year-old person, in addition to the sofa, the dining table, the refrigerator, and the bookshelf. The spaces occupied by the added possessions are: SX4 and SY4, respectively.

FIG. 2C is an illustration showing a third example of the standard information according to this embodiment.

Like FIG. 2A or 2B, FIG. 2C shows, for the respective ages of people, the types of standard possessions owned by the people and the spaces occupied by these possessions in association with each other. FIG. 2C additionally shows whether the respective possessions shown in FIG. 2B are for personal use or shared by the family. Note that the letter “P” or “F” is shown in the brackets following the name of each possession in addition to the space occupied by the possession. “P” represents a personal possession, and “F” represents a possession shared by the family.

For example, a sofa, a low table, a refrigerator, books, and clothes are shown as the standard possessions owned by a 20 year-old person. The figure shows all of these as personal possessions.

For example, a sofa, a dining table, a refrigerator, a cupboard, books, clothes, and tableware are shown as the standard possessions owned by a 30 year-old person. The figure shows the books and the clothes as personal possessions and the others as possessions shared by the family.

For example, a sofa, a dining table, a refrigerator, a bookshelf, books, and clothes are shown as standard possessions owned by a 40 year-old person. The figure shows the bookshelf, the books, and the clothes as personal possessions and the others as possessions shared by the family.

Note that the possessions shared by the family may be associated with a predetermined one of the residents. The predetermined one may be the one determined as the head or representative, or the oldest of household.

FIG. 3 is an illustration showing an example of attribute information and possession information according to this embodiment.

FIG. 3 shows respective attribute information on the residents and the possession information indicating the possessions owned by the residents in association with each other. The possession information includes information indicating the types of the possessions and the information indicating the spaces occupied by these possessions.

Specifically, FIG. 3 shows the respective attribute information on three residents.

The attribute information includes at least the ages. The ages of the three residents shown in FIG. 3 are: 33; 36; and 6. Note that the attribute information may include the sexes together with the ages. In this case, the ages and sexes of the three residents shown in FIG. 3 may be 33 (male), 36 (female), and 6 (male), for example. In this case, the 33 year-old male may be the person determined as the head of household.

FIG. 3 shows the respective possession information on the three residents in association with the attribute information.

For example, a sofa, a dining table, a refrigerator, and a cupboard are shown as the possessions owned by the 33 year-old resident. The spaces occupied by these possessions are: A, B, C, and D, respectively.

For example, a low table, a storage case, and a piano are shown as the possessions owned by the 36 year-old resident. The spaces occupied by these possessions are: F, G, and H, respectively.

For example, a storage box and a study desk are shown as the possessions owned by the 6 year-old resident. The spaces occupied by these possessions are: J and K, respectively.

Calculator 13 obtains the amount information from the possession information by referring to the standard information shown in FIG. 2A. For example, if the standard information on the 33 year-old resident is the same as the standard information on the 30 year-old resident, calculator 13 obtains the amount information by dividing the spaces occupied by possessions (A+B+C+D+ . . . ) owned by the 33 year-old resident by the standard spaces (SA3+SB3+SC3+SD3+ . . . ) for the possessions of the 30 year-old resident.

Now, specific examples of the future information generated by provider 14 will be described. The future information generated by provider 14 can include (1) string information indicating the spaces occupied by possessions, (2) a floor plan image including the possessions, or (3) a 3D-image including the possessions. Each of the information will be described in detail below.

### (1) String Information Indicating Spaces Occupied by Possessions

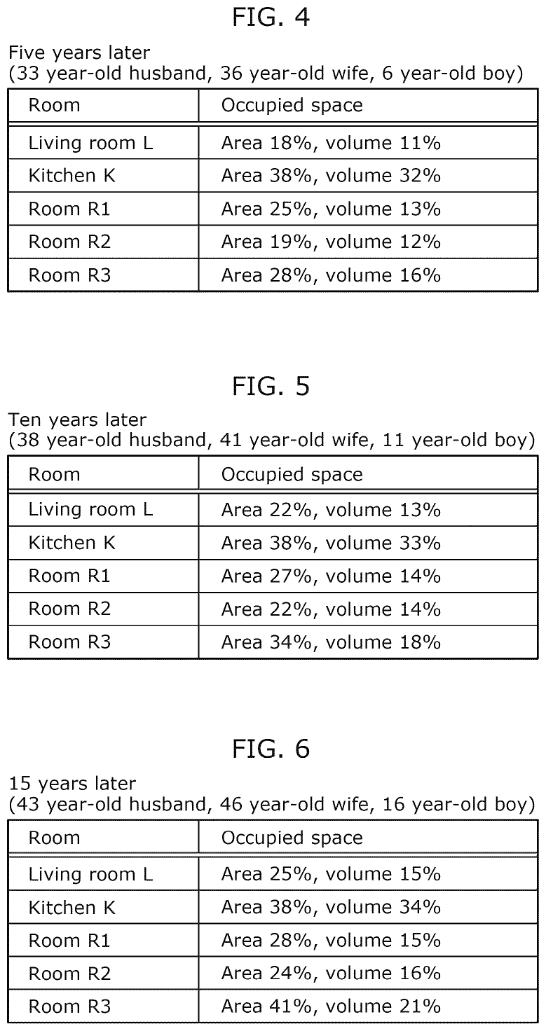

FIG. 4 is an illustration showing a first example of the string information indicating the spaces occupied by the possessions according to this embodiment. The string information shown in FIG. 4 is an example of the future information indicating possessions to be owned by residents after five years from a reference point in time. An example will be described here where provider 14 obtains the future information for each room of the residence.

For example, FIG. 4 shows the space occupied by possessions in living room L is 18% in area and 11% in volume. Each of these numerical values is the percentage of the following information with respect to the area or volume of living room L. The information is obtained by multiplying the standard space for the possessions to be owned by the residents after five years from the reference point in time by the amount information.

The same applies to the other rooms shown in FIG. 4.

FIG. 5 is an illustration showing a second example of the string information indicating the spaces occupied by possessions according to this embodiment. The string information shown in FIG. 5 is an example of the future information indicating possessions to be owned by residents after ten years from the reference point in time.

For example, FIG. 5 shows the space occupied by possessions in living room L is 22% in area and 13% in volume. Each of these numerical values is the percentage of the following information with respect to the area or volume of living room L. The information is obtained by multiplying the standard space for the possessions to be owned by the residents after ten years from the reference point in time by the amount information.

The same applies to the other rooms shown in FIG. 5.

FIG. 6 is an illustration showing a third example of the string information indicating the spaces occupied by possessions according to this embodiment. The string information shown in FIG. 6 is an example of the future information indicating possessions to be owned by residents after 15 years from the reference point in time.

For example, FIG. 6 shows the space occupied by possessions in living room L is 25% in area and 15% in volume. Each of these numerical values is the percentage of the following information with respect to the area or volume of living room L. The information is obtained by multiplying the standard space for the possessions to be owned by the residents after 15 years from the reference point in time by the amount information.

The same applies to the other rooms shown in FIG. 6.

Note that the string information shown in FIGS. 4 to 6 may be displayed in the locations of the rooms in a floor plan image. The examples of this case will be described below.

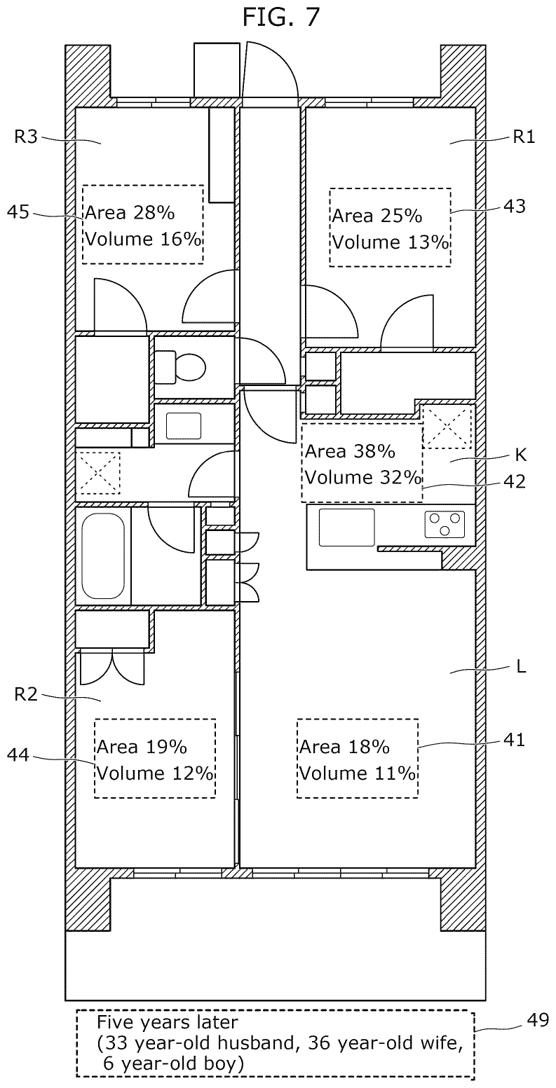

FIG. 7 is an illustration showing a first example of the floor plan image according to this embodiment. The floor plan image shown in FIG. 7 is an example of the future information indicating possessions to be owned by residents after five years from the reference point in time.

FIG. 7 shows an image obtained by combining string information 41, 42, 43, 44, and 45 with, as a base, an image showing the floor plan of a residence in the locations of the rooms (specifically, living room L, kitchen K, and rooms R1, R2, and R3) of the residence. String information 41, 42, 43, 44, and 45 indicates the spaces occupied by possessions in the rooms after five years from the reference point in time. String information 41 to 45 is the same as in FIG. 4 and description thereof will thus be omitted.

Note that the floor plan image may include string information 49 including the years elapsed from the reference point in time, information on the residents or the attribute information on the residents. The same applies to the following.

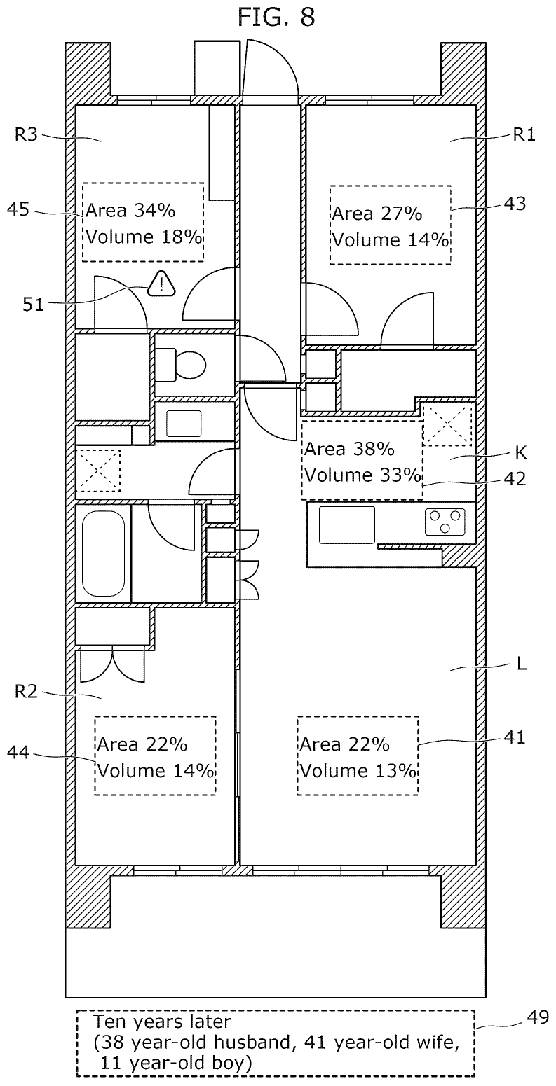

FIG. 8 is an illustration showing a second example of the floor plan image according to this embodiment. The floor plan image shown in FIG. 8 is an example of the future information indicating the possessions to be owned by the residents after ten years from the reference point in time.

FIG. 8 shows an image obtained by combining string information 41, 42, 43, 44, and 45 with, as a base, an image showing the floor plan of a residence, in the locations of the rooms (specifically, living room L, kitchen K, and rooms R1, R2, and R3) of the residence. String information 41, 42, 43, 44, and 45 indicates the spaces occupied by the possessions in the rooms after ten years from the reference point in time. String information 41 to 45 is the same as in FIG. 5 and description thereof will thus be omitted.

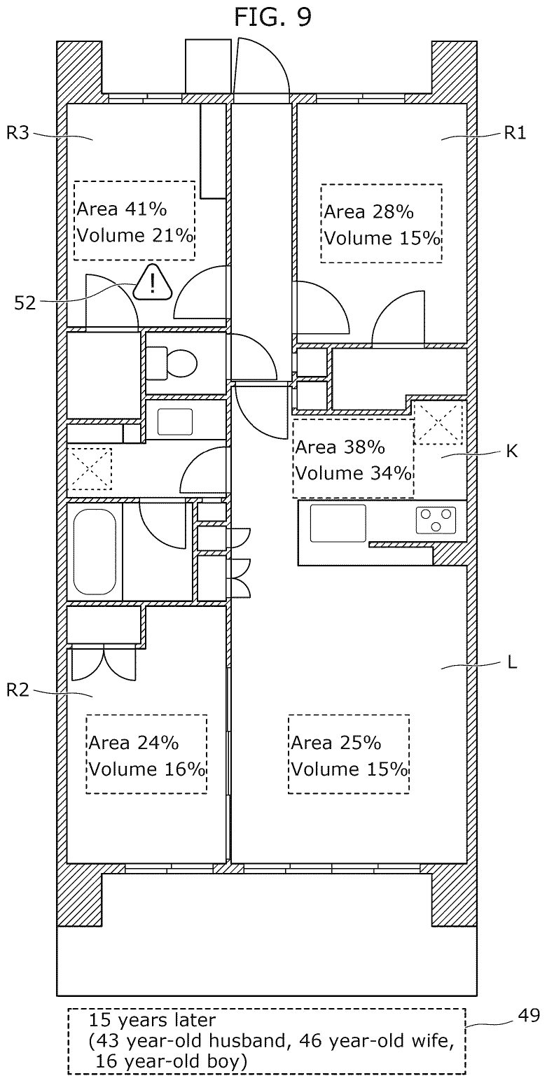

FIG. 9 is an illustration showing a third example of the floor plan image according to this embodiment. The floor plan image shown in FIG. 9 is an example of the future information indicating the possessions to be owned by the residents after 15 years from the reference point in time.

FIG. 9 shows an image obtained by combining string information 41, 42, 43, 44, and 45 with, as a base, an image showing the floor plan of a residence, in the locations of the rooms (specifically, living room L, kitchen K, and rooms R1, R2, and R3) of the residence. String information 41, 42, 43, 44, and 45 indicates the spaces occupied by possessions in the rooms after 15 years from the reference point in time. String information 41 to 45 is the same as in FIG. 6 and description thereof will thus be omitted.

Note that a mark indicating a relatively large occupied space may be given to a room whose occupied space is over a threshold. The threshold may include a plurality of thresholds. For example, if two thresholds 30% and 40% in area are provided, mark 51 (see FIG. 8) is given to a room with an area whose occupied space is over 30% in area and mark 52 (see FIG. 9) is given to a room whose occupied space is 40% in area. In this case, mark 51 contributes to informing the user of the fact that a relatively low level of attention is to be paid, and mark 52 contributes to informing the user of the fact that a higher level of attention than mark 51 is to be paid. Marks 51 and 52 may reflect the degrees of the attentions to be paid by the user. Specifically, mark 52 may be in a larger size than mark 51, may be in a more conspicuous color than mark 51, or may include a more conspicuous sign or string than mark 51, in accordance with the degrees of the attentions to be paid.

### (2) Floor Plan Image Including Possessions

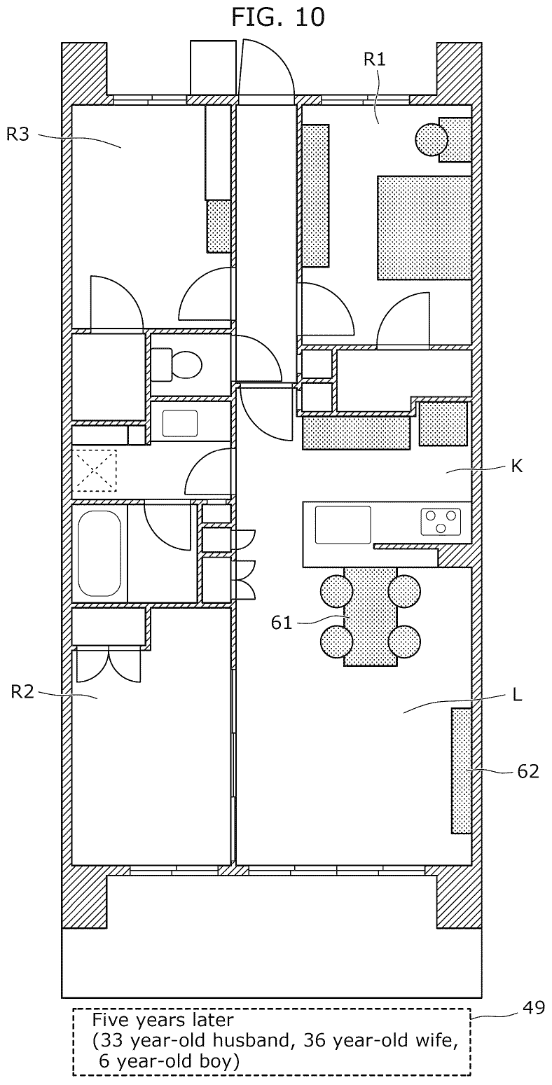

FIG. 10 is an illustration showing a fourth example of the floor plan image according to this embodiment. The floor plan image shown in FIG. 10 is an example of the future information indicating possessions to be owned by the residents after five years from the reference point in time.

FIG. 10 shows an image obtained by combining possessions 61 and 62 with, as a base, an image showing the floor plan of a residence in the respective locations of the rooms (specifically, living room L, kitchen K, and rooms R1, R2, and R3) of the residence after five years from the reference point in time.

As an example, FIG. 10 shows that possessions 61 and 62 are located in living room L. Possession 61 is a dining table as an example of the possessions, and possession 62 is a TV stand as an example of the possessions. Possessions 61 and 62 are owned by one of the residents. The locations of possessions 61 and 62 may be set based on the points determined in advance in accordance with the types of the possessions. For example, the dining table may be set at a point near the kitchen counter and the TV stand may be set at a point on a relatively long wall surface in living room L.

The same applies to the other rooms shown in FIG. 10.

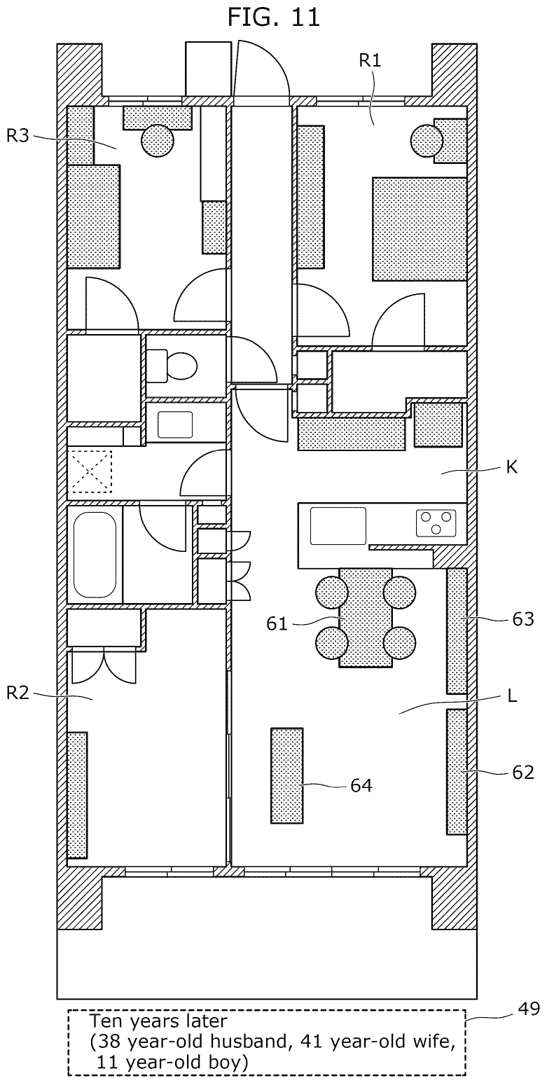

FIG. 11 is an illustration showing a fifth example of the floor plan image according to this embodiment. The floor plan image shown in FIG. 11 is an example of the future information indicating possessions to be owned by the residents after ten years from the reference point in time.

FIG. 11 shows an image obtained by combining possessions 61, 62, 63, and 64 with, as a base, an image showing the floor plan of a residence in the respective locations of the rooms (specifically, living room L, kitchen K, and rooms R1, R2, and R3) of the residence after ten years from the reference point in time.

As an example, FIG. 11 shows that possessions 61, 62, 63, and 64 are located in living room L. Possessions 61 and 62 are the same as in FIG. 10. Possession 63 is a bookshelf as an example of the possessions, and possession 64 is a sofa as an example of the possessions. Possessions 63 and 64 are owned by one of the residents. For example, the bookshelf may be set at a point on a relatively long wall surface in living room L. The sofa may be set at a point away from the other possessions in living room L. If a TV stand is located in living room L, the sofa may be opposed to the TV stand.

The same applies to the other rooms shown in FIG. 11.

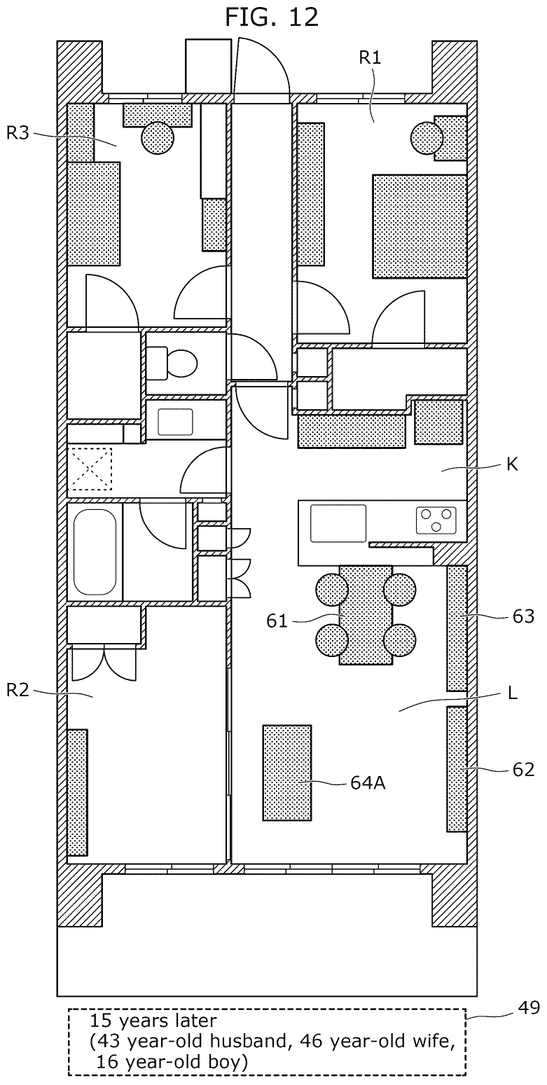

FIG. 12 is an illustration showing a sixth example of the floor plan image according to this embodiment. The floor plan image shown in FIG. 12 is an example of the future information indicating possessions to be owned by the residents after 15 years from the reference point in time.

FIG. 12 shows an image obtained by combining possessions 61, 62, 63, and 64A with, as a base, an image showing the floor plan of a residence in the respective locations of the rooms (specifically, living room L, kitchen K, and rooms R1, R2, and R3) of the residence after 15 years from the reference point in time.

As an example, FIG. 12 shows that possessions 61, 62, 63, and 64A are located in living room L. Possessions 61, 62, and 63 are the same as in FIG. 11. Possession 64A is a sofa as an example of the possessions and occupies a larger space than possession 64 shown in FIG. 11.

The same applies to the other rooms shown in FIG. 12.

### (3) 3D-Image Including Possessions

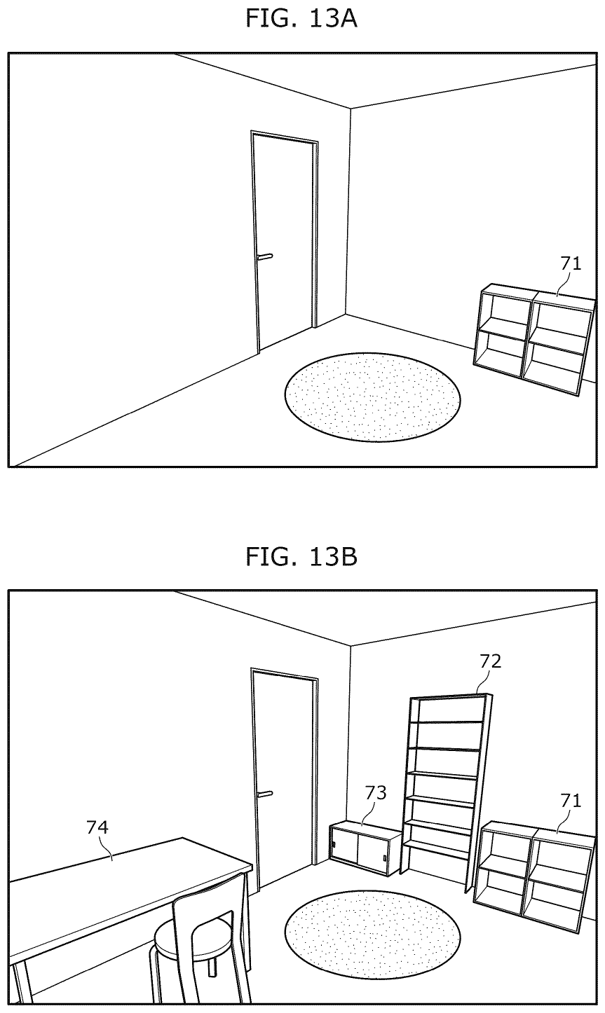

FIG. 13A is an illustration showing a first example of the 3D-image according to this embodiment. The 3D-image shown in FIG. 13A is an example of the future information indicating possessions to be owned by residents after five years from the reference point in time.

FIG. 13A shows an image obtained by combining a 3D-image showing possession 71 in a room after five years from the reference point in time with, as a base, a 3D-image showing the inside of the room (e.g., a child's room) from a point of view in the room. The 3D-image as the base described above shows the celling, floor, walls, door, or other members as building and other materials of the residence.

If terminal 20 includes sensor 24, the image shown in FIG. 13A corresponds to a 3D-image showing the inside of the residence seen from terminal 20 at the location and orientation indicated by the location and orientation information obtained by sensor 24.

Possession 71 shown in FIG. 13A is a storage shelf as an example of the possessions. Possession 71 is owned by one of the residents. The location of possession 71 can be set based on the point determined in advance in accordance with the type of the possession. For example, the storage shelf may be set at point on a wall surface with a larger width than the storage shelf, out of the wall surfaces of the room.

FIG. 13B is an illustration showing a second example of the 3D-image according to this embodiment. The 3D-image shown in FIG. 13B is an example of the future information indicating possessions to be owned by residents after ten years from the reference point in time.

FIG. 13B shows an image obtained by combining a 3D-image showing possessions 71, 72, 73, and 74 in a room after ten years from the reference point in time with, as a base, the same 3D-image as in FIG. 13A.

Possession 71 shown in FIG. 13B is the same as in FIG. 13A. Possession 72 is a bookshelf as an example of the possessions. Possessions 73 is a storage box as an example of the possessions. Possession 74 is a study desk as an example of the possessions.

For example, the bookshelf may be set at point on a wall surface with a larger width than the bookshelf, out of the wall surfaces of the room.

Note that the 3D-image including possessions not only include furniture but may include movables, such as books or clothes, used in daily life, in addition to the furniture. The movables used in daily life may be selected in accordance with the age or sex of a person assumed to use the room. This case will be described.

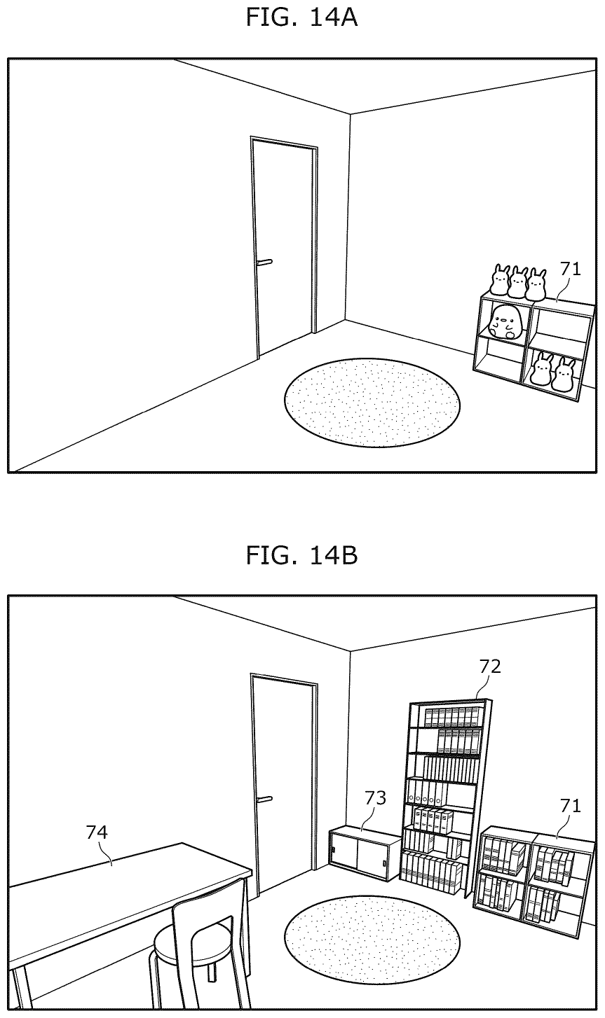

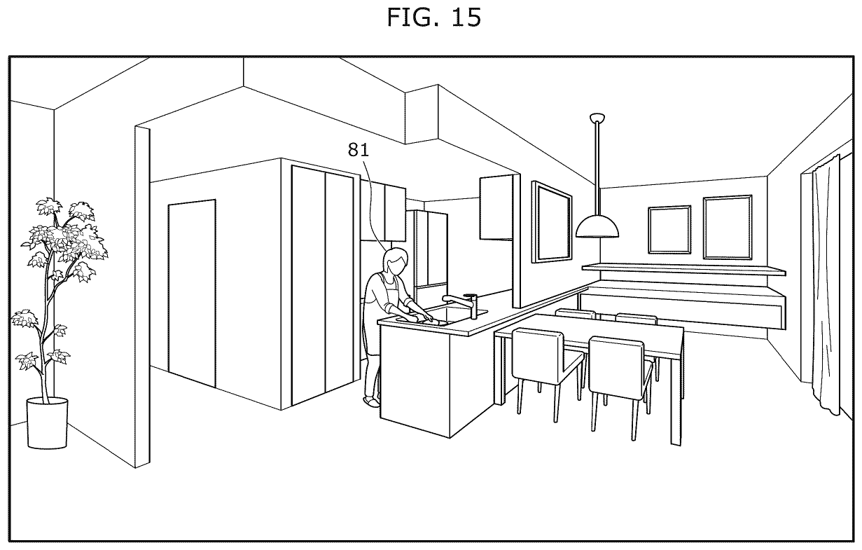

FIG. 14A is an illustration showing a third example of the 3D-image according to this embodiment.

FIG. 14A shows stuffed toys placed on possession 71 in the room shown in FIG. 13A. The stuffed toys are examples of the movables used in daily life by the person (e.g., 6 year-old child) assumed to use the room.

FIG. 14B is an illustration showing a fourth example of the 3D-image according to this embodiment.

FIG. 14B shows books or picture books placed on possessions 71 and 72 in the room shown in FIG. 13B. The books or picture books are examples of the movables used in daily life by the person (e.g., 11 year-old child) assumed to use the room.

Accordingly, the user can image a change in the necessary space required in the resident in the future more specifically.

If terminal 20 includes sensor 24, the images shown in FIGS. 13A to 14B correspond to 3D-images showing the inside of the residence seen from terminal 20 at the location and orientation indicated by the location and orientation information obtained by sensor 24.

Now, future information in the form of an image including an avatar of a resident will be described.

FIG. 15 is an illustration showing a third example of the 3D-image according to this embodiment. The 3D-image shown in FIG. 15 is an example of the future information indicating possessions to be owned by the residents after several years from the reference point in time.

Like FIGS. 13A to 14B, FIG. 15 shows a 3D-image showing the inside of a room from a point of view in the room.

FIG. 15 shows an image of avatar 81 of a resident. Avatar 81 corresponds to at least one of the one or more residents of the residence. Note that the residents may include users visiting the residence regularly or irregularly, pets, robots, or others.

Avatar 81 can be put in a place in which the resident stays at a relatively high frequency in the residence and a position often taken by the resident in the place. If the attribute information includes the place in which the resident stays at a relatively high frequency in the residence and the position often taken by the resident in the place, the location and orientation of avatar 81 may be determined based on the attribute information.

For example, avatar 81 shown in FIG. 15 is the mother (or the wife) of a family. Avatar 81 corresponds to the residence with the attribute information indicating that the kitchen is the “place in which the resident stays at a relatively high frequency in the residence” and the standing is the “position often taken by the resident in the place”.

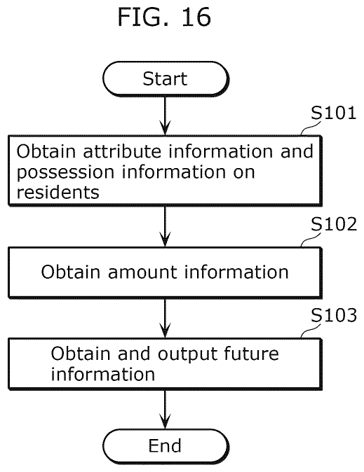

FIG. 16 is a flowchart showing the processing (also referred to as the “information processing method”) to be executed by server 10 according to this embodiment.

In step S101, server 10 obtains attribute information and possession information. The possession information includes the ages of the one or more residents of the residence. The possession information indicates the possessions owned by the one or more residents.

In step S102, server 10 compares the standard spaces for the one or more residents obtained from the attribute information and the standard information to the space occupied by possessions indicated by the possession information to obtain amount information indicating the amount of the possessions owned by the one or more residents. The standard information is referred to for obtaining the amount information.

In step S103, server 10 obtains and outputs future information indicating possessions to be owned by the one or more residents in the future by correcting the standard information using the amount information obtained in step S102.

Accordingly, server 10 can provide the user with information indicating the space required in the residence in the future.

In the embodiment described above, the elements may be achieved by dedicated hardware or by executing software programs suitable for the elements. The elements may be achieved by a program executor, such as a CPU or a processor, which reads out software programs stored in a recording medium, such as a hard disk or a semiconductor memory, and executes the read-out programs. The software implementing the server according to the embodiment described above is the following program.

Specifically, this program is for causing a computer to execute an information processing method to be executed by an information processing device using a processor. The information processing method includes: obtaining attribute information and possession information, the attribute information including ages of one or more users at a reference point in time, the possession information indicating possessions owned by the one or more users at the reference point in time; the obtaining amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and obtaining future information indicating possessions to be owned by the one or more users in future by correcting the standard information using the amount information obtained, and providing the future information.

While the information processing method, and so on, according to one or more aspects have been described above based on the embodiment, the present disclosure is not limited to the embodiment. The one or more aspects of the present disclosure may include forms obtained by various modifications to the foregoing embodiment that can be conceived by those skilled in the art or forms achieved by freely combining the elements in the foregoing embodiment without departing from the scope and spirit of the present disclosure.

### INDUSTRIAL APPLICABILITY

The present disclosure is useful for a system that provides information on a residence.

1. An information processing method to be executed by an information processing device using a processor, the information processing method comprising:
obtaining attribute information and possession information, the attribute information including ages of one or more users at a reference point in time, the possession information indicating possessions owned by the one or more users at the reference point in time;
the obtaining amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and
obtaining future information indicating possessions to be owned by the one or more users in future by correcting the standard information using the amount information obtained, and providing the future information.

2. The information processing method according to claim 1, wherein
the obtaining of the future information includes:
obtaining, as the future information, an image obtained by combining an image showing the possessions to be owned by the one or more users in the future with an image showing a facility in which at least one of the users considers living.

3. The information processing method according to claim 1, wherein
the obtaining of the future information includes:
obtaining, as the future information, an image obtained by combining a three-dimensional (3D) image showing the possessions to be owned by the one or more users in the future with a 3D image showing a facility in which at least one of the users considers living.

4. The information processing method according to claim 1, further comprising:
obtaining location and orientation information indicating a location and an orientation of a terminal, wherein
the obtaining of the future information includes:
obtaining, as the future information, a three-dimensional (3D) image obtained by combining a 3D-image showing possessions to be owned by the one or more users in the future with a 3D-image showing the facility in which the user considers living, and providing the 3D-image to the terminal.

5. The information processing method according to claim 1, wherein
the obtaining of the future information includes:
obtaining, as the future information, an image obtained by combining an image showing possessions to be owned by the one or more users in the future with an image showing a floor plan of the facility in which the user considers living.

6. The information processing method according to claim 1, wherein
the obtaining of the future information includes:
obtaining the future information including an image of an avatar of at least one of the one or more users who consider living to the facility.

7. The information processing method according to claim 1, wherein
the obtaining of the future information includes:
obtaining, as the future information, string information indicating spaces to be occupied by possessions to be owned by the one or more users in the future.

8. The information processing method according to claim 1, wherein
the obtaining of the future information includes:
obtaining future information indicating possessions to be owned by the one or more users after N years, where N is an integer of one or more, from the reference point in time.

9. The information processing method according to claim 1, wherein
the attribute information further includes sexes or occupations of the one or more users, and
the standard information indicates the standard spaces occupied by possessions owned by the people and determined in advance for the ages of the people and sexes or occupations of the people.

10. The information processing method according to claim 1, wherein
the facility to which the user considers living is a residence, and
the one or more users are one or more residents who consider living to the residence.

11. An information processing device comprising:
an obtainer that obtains attribute information and possession information, the attribute information including ages of one or more users at a reference point in time, the possession information indicating possessions owned by the one or more users at the reference point in time;
a calculator that obtains, using a processor, amount information indicating an amount of the possessions owned by the one or more users, by referring to standard information indicating standard spaces determined in advance for ages of people and occupied by standard possessions owned by the people and by comparing standard spaces for the one or more users obtained from the attribute information and the standard information to spaces occupied by the possessions indicated by the possession information; and
a provider that obtains and provides future information indicating possessions to be owned by the one or more users in future by correcting the standard information using the amount information obtained.

12. An information processing system comprising:
the information processing device according to claim 11, and
a terminal including a display that displays the future information provided by the information processing device.

13. A non-transitory computer-readable recording medium for use in a computer, the recording medium having recorded thereon a computer program for causing the computer to execute the information processing method according to claim 1.
